(19) United States
(12) Patent Application Publication
(10) Pub. No.: US 2012/0106756 A1
(43) Pub. Date: May 3, 2012

(54) SYSTEM AND METHOD FOR A NOISE REDUCTION SWITCH IN A COMMUNICATION DEVICE

(76) Inventor: Alon Konchitsky, Santa Clara, CA (US)

(21) Appl. No.: 13/286,034

(22) Filed: Oct. 31, 2011

Related U.S. Application Data
(60) Provisional application No. 61/408,975, filed on Nov. 1, 2010.

(51) Int. Cl. H04B 15/00

(52) U.S. Cl. 381/94.1

(57) ABSTRACT

A switch system and novel method control the application of noise reduction upon a signal.

### CROSS-REFERENCE TO RELATED APPLICATIONS

This is a utility application based upon U.S. patent application Ser. No. 61/408,975 filed on Nov. 1, 2010. This related application is incorporated herein by reference and made a part of this application. If any conflict arises between the disclosure of the invention in this utility application and that in the related provisional application, the disclosure in this utility application shall govern. Moreover, the inventors incorporate herein by reference any and all patents, patent applications, and other documents hard copy or electronic, cited or referred to in this application.

### FIELD OF THE INVENTION

The invention relates to processing of audio signals and more specifically the invention relates to systems and method for a noise reduction switch in communication devices.

### BACKGROUND

Background noise or ambient noise is any sound other than the sound being monitored. Typically, background noise may be caused by engines, blowers, fans, air conditioners, cars, busy intersections, people talking in restaurants etc. If untreated, background noise can be annoying at times. Further, background noise is a major problem when processing audio signals.

Modern day communication devices operate in a myriad type of environments. Examples of communication devices include, but are not limited to, a mobile phone, wireless telephone as so forth. Some of the environments may be extremely noisy, for example bars, crowded restaurants and so forth, while some environments may be extremely quite such as home, relaxing lounge and so forth. Generally, the communication devices include microphone(s) that pick up the desired signal of the user and background noise (if present). As a result, the communication at the other end may not be clearly discernible or pleasant.

Typically for noise reduction, the audio signal is processed in a microprocessor by using noise reduction algorithms. The audio signal is picked up by the microphone, digitized by an Analog to Digital Converter (ADC) and fed to the microprocessor for analysis and noise reduction. The noise reduction algorithms, however, come at an expense of battery life, power, MIPS (Millions of Instructions per Second), huge program space, data space, crucial processing time and so forth. Moreover, the communication devices may not always be used in noisy environments. Further, voice gateways, conference bridges and similar devices may be overloaded if the noise reduction algorithms are continuously executed. As a result, the noise reduction algorithms may not be desired to be executed at all the times.

In light of the above discussion, techniques are required to switch (enable or disable) the noise reduction in communication devices based on the background noise in which the device is operating.

### SUMMARY OF THE INVENTION

The present invention provides a novel system and method for monitoring the audio signals, analyze selected audio signal components, compare the results of analysis with a threshold value, and switch the noise reduction capability of a communication device.

In one aspect of the invention, the threshold can be pre-defined by the user, manufacturer or can be set “on the fly” in real time during a telephonic conversation.

In another aspect of the invention, the invention can be used in communication devices which perform noise reduction on the received signals which are reproduced at the earpiece of the communication device.

In another aspect of the invention, the invention provides the flexibility to disable noise reduction if there is no background noise or if it is less than the set threshold to save crucial processing times, data space, program space required by the complex noise reduction algorithms. This technique increases the channel capacity in gateways, conference bridges, networks, servers and any multi-channel environment.

In another aspect of the invention, the invention provides flexibility to the users so they can “by-pass” the noise reduction by modifying the threshold and preserve the voice quality which are altered/modified by noise reduction algorithms.

In yet another aspect of the invention, the invention can be added as a module to the already existing devices with noise reduction capability. In such cases, the current invention enhances the battery life, reduces the power consumption, MIPS etc. However, it does not interfere with the native noise reduction algorithms.

In another aspect of the invention, clear voice is provided both in presence and absence of background noise in voice communication systems, devices, telephones, voice communication gateways, multi-channel environments and so forth.

Other features and advantages of the invention will become apparent to one with skill in the art upon examination of the following figures and detailed description. All such features, advantages are included within this description and be within the scope of the invention and be protected by the claims.

### BRIEF DESCRIPTION OF THE DRAWINGS

The invention is better understood in conjunction with detailed description and the figures. It should be noted that the components, blocks in the figures are not to scale and are used only for descriptive purposes.

FIG. 1A illustrates an exemplary embodiment of the noise reduction switch as discussed in the current invention;

FIG. 1B illustrates components of the noise reduction switch, in accordance with an embodiment of the invention;

FIG. 2 illustrates an exemplary implementation of the current invention in a Bluetooth headset;

FIG. 3 illustrates an exemplary implementation of the current invention in a mobile phone;

FIG. 4 illustrates an exemplary implementation of the current invention in a cordless phone;

FIG. 5 illustrates an exemplary implementation of the current invention in a VoIP gateway;

FIG. 6 illustrates an exemplary implementation of the current invention in a conference bridge environment;

FIG. 7A is a flowchart of a system with noise reduction switch, in accordance with an embodiment of the invention;

FIG. 7B is a flowchart detailing the steps of the noise reduction switch.

FIG. 8A illustrates graphical representation of clean speech with no background noise;

FIG. 8B illustrates graphical representation of the noise reduction switch for an audio signal of FIG. 8A;

FIG. 8C illustrates graphical representation of the unmodified audio signal of FIG. 8A;

FIG. 9A illustrates graphical representation of clean speech corrupted with background noise; and

FIG. 9B illustrates graphical representation of the noise reduction switch for an audio signal of FIG. 9A.

FIG. 9C illustrates graphical representation of the modified audio signal of FIG. 9A;

### DETAILED DESCRIPTION OF EMBODIMENTS OF THE INVENTION

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout.

Unless otherwise noted in this specification or in the claims, all of the terms used in the specification and the claims will have the meanings normally ascribed to these terms by workers in the art.

Hereinafter, preferred embodiments of the invention will be described in detail in reference to the accompanying drawings. It should be understood that like reference numbers are used to indicate like elements even in different drawings. Detailed descriptions of known functions and configurations that may unnecessarily obscure the aspect of the invention have been omitted.

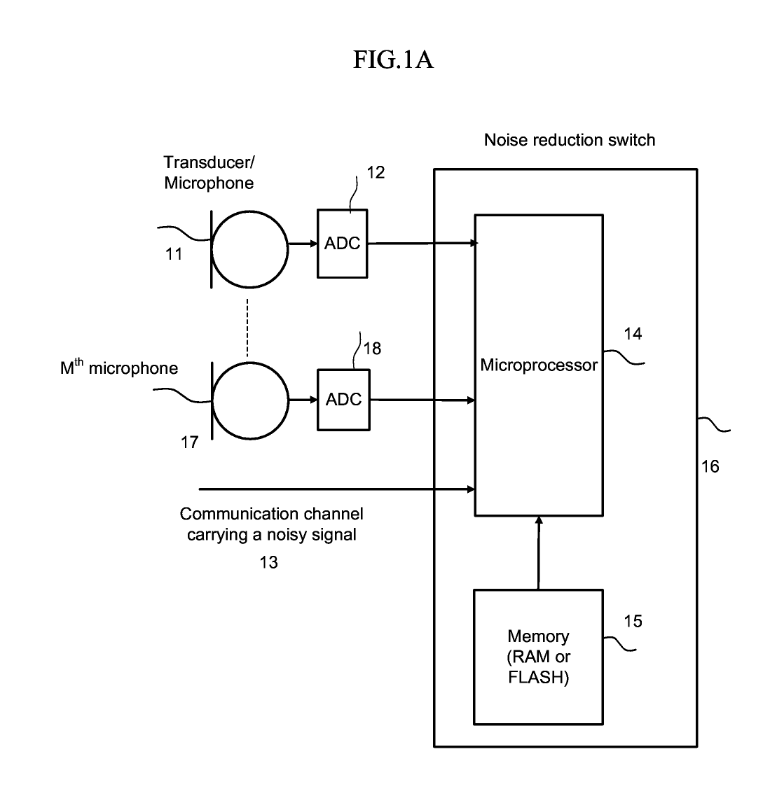

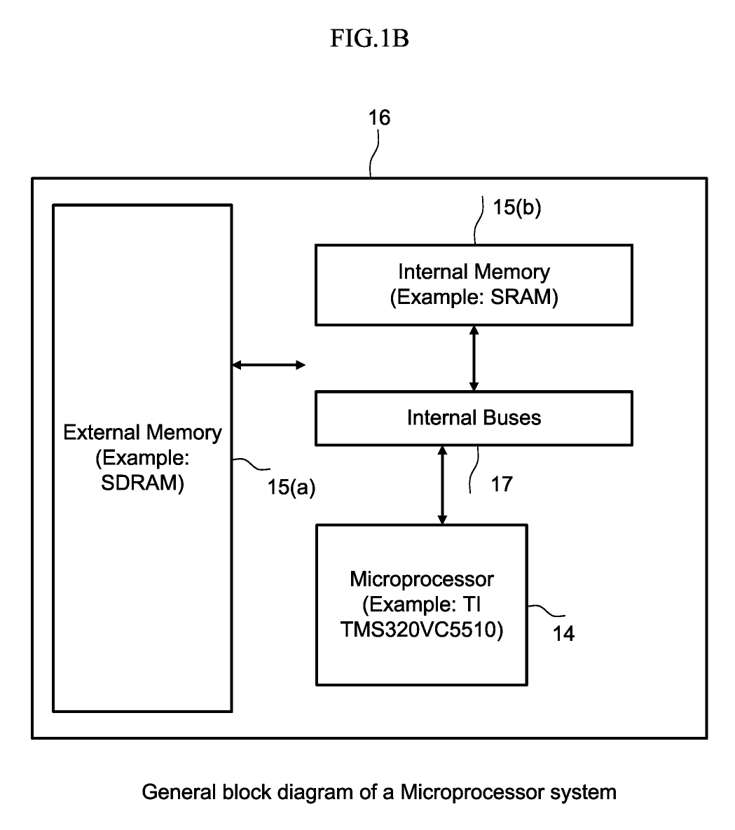

FIG. 1A shows the embodiments of the noise reduction switch as described in the current invention. The transducer/microphone, 11, of the communication device, picks up the analog signal. It should be noted by people skilled in the art that the communication device can have M number of microphone(s), where M>1. The Analog to Digital Converter (ADC), block 12, converts the analog signal to digital signal. Block 17 and 18 are M^{th} microphone and ADC respectively for a communication device with M microphones. The digital signal is then sent to the noise reduction switch, block 16. In general any communication signal received from a communication device, in its digital form, is sent to the noise reduction switch. The noise reduction switch (block 16) consists of a microprocessor, block 14 and a memory, block 15. The microprocessor can be a general purpose Digital Signal Processor (DSP), fixed point or floating point, or a specialized DSP (fixed point or floating point).

Examples of DSP include Texas Instruments (TI) TMS320VC5510, TMS320VC6713, TMS320VC6416 or Analog Devices (ADI) BF531, BF532, 533 etc or Cambridge Silicon Radio (CSR) Blue Core 5 Multi-media (BC5-MM) or Blue Core 7 Multi-media BC7-MM etc. In general, the noise reduction switch can be implemented on any general purpose fixed point/floating point DSP or a specialized fixed point/floating point DSP.

The memory can be Random Access Memory (RAM) based or FLASH based and can be internal (on-chip) or external memory (off-chip). The instructions reside in the internal or external memory. The microprocessor, in this case a DSP, fetches instructions from the memory and executes them.

FIG. 1B shows the embodiments of block 16. It is a general block diagram of a microprocessor system where noise reduction switch is implemented. The internal memory, block 15(b) for example, can be SRAM (Static Random Access Memory) and the external memory, block 15(a) for example, can be SDRAM (Synchronous Dynamic Random Access Memory). The microprocessor, block 14 for example, can be TI TMS320VC5510. However, those skilled in the art can appreciate the fact that the block 14, can be a microprocessor, a general purpose fixed/floating point DSP or a specialized fixed/floating point DSP. The internal buses, block 17, are physical connections that are used to transfer data. All the instructions required by the noise reduction switch reside in the memory and are executed in the microprocessor.

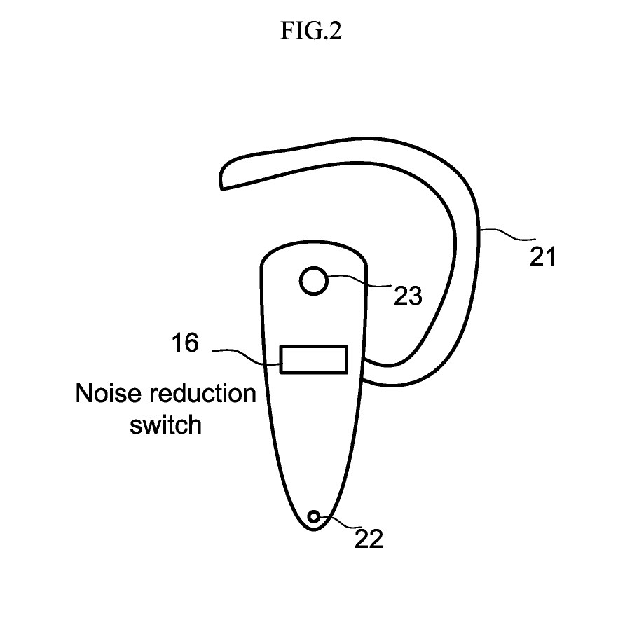

FIG. 2 shows a Bluetooth headset with the noise reduction switch. In FIG. 2, 22 is the microphone of the device. 23 is the speaker of the device. 21 is the ear hook of the device. Block 16 is the noise reduction switch which decides if the noise reduction should be enabled or disabled. People skilled in the art can appreciate the fact that the Bluetooth headset can have M number of microphone(s), where M≧1.

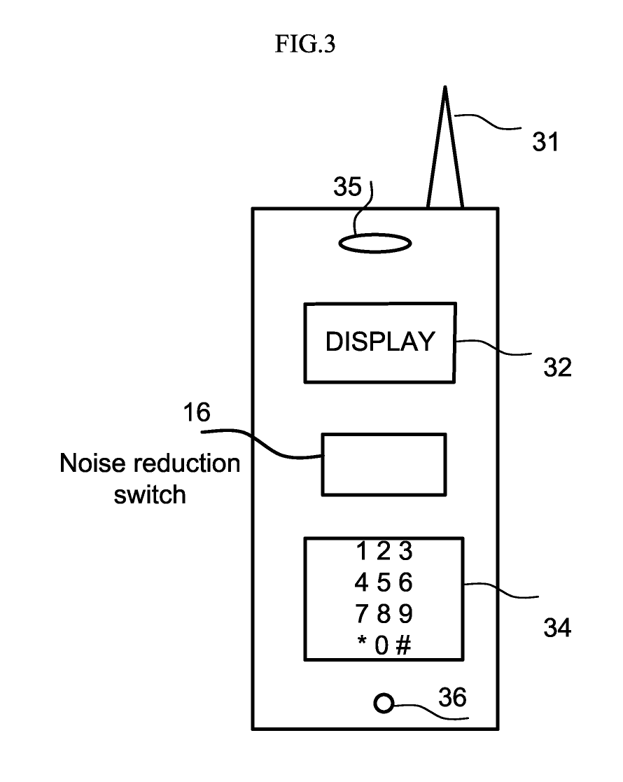

FIG. 3 shows a cell phone with the noise reduction switch. In FIG. 3, 31 is the antenna of the cell phone, 35 is the loudspeaker. 36 is the microphone. 32 is the display, 34 is the keypad of the cell phone. Block 16 is the noise reduction switch which decides if the noise reduction should be enabled or disabled. People skilled in the art can appreciate the fact that the cell phone can have M number of microphone(s), where M≧1.

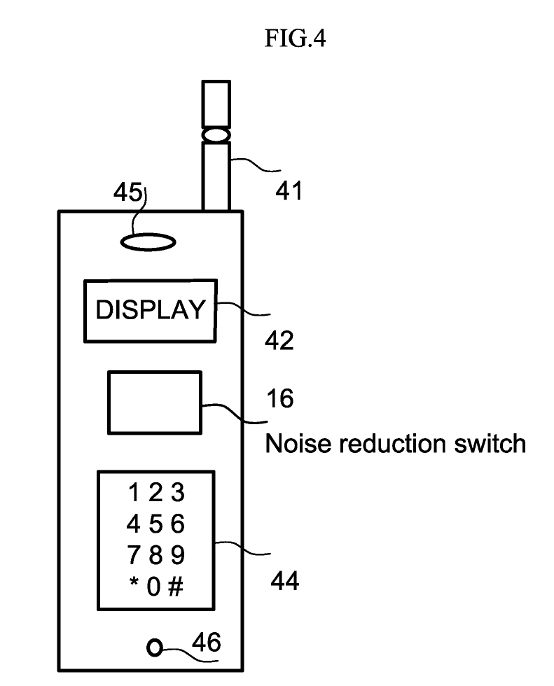

FIG. 4 shows a cordless phone with the noise reduction switch. In FIG. 4, 41 is the antenna of the cell phone, 45 is the loudspeaker. 46 is the microphone. 42 is the display, 44 is the keypad of the cell phone. Block 16 is the noise reduction switch which decides if the noise reduction should be enabled or disabled. People skilled in the art can appreciate the fact that the cordless phone can have M number of microphone(s), where M≧1.

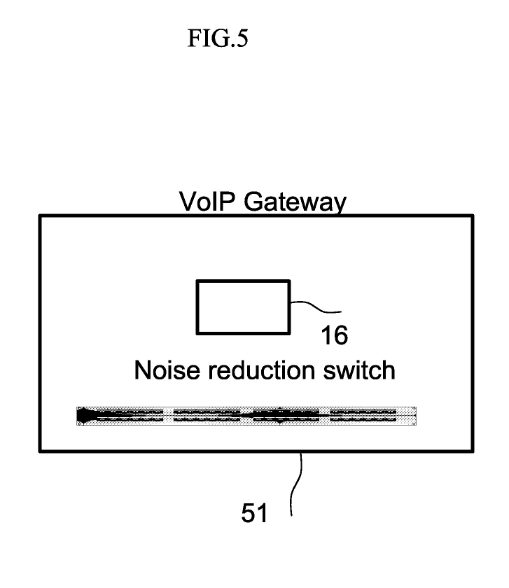

FIG. 5 shows a VoIP gateway, 51 with the noise reduction switch. Block 16 is the noise reduction switch which decides if the noise reduction should be enabled or disabled. People skilled in the art can appreciate the fact that the gateway can have single channel or multi channels.

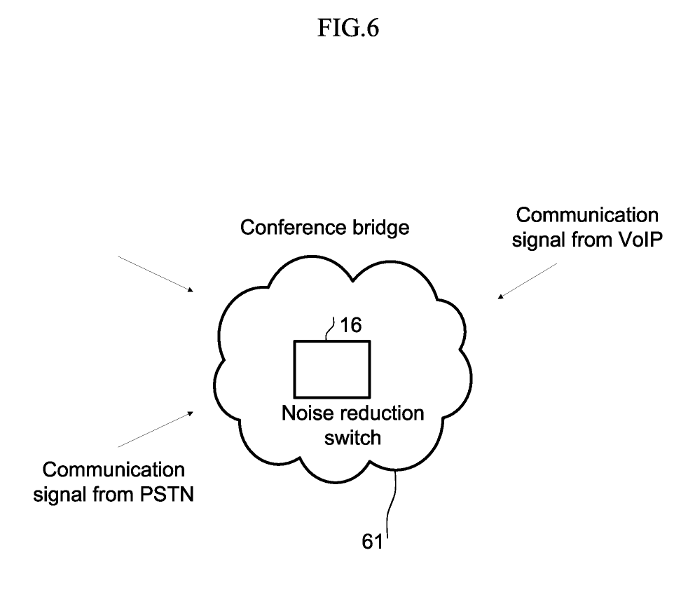

FIG. 6 shows a conference bridge, 61 with the noise reduction switch. Block 16 is the noise reduction switch which decides if the noise reduction should be enabled or disabled. People skilled in the art can appreciate the fact that the conference bridge can have single channel or multi channels.

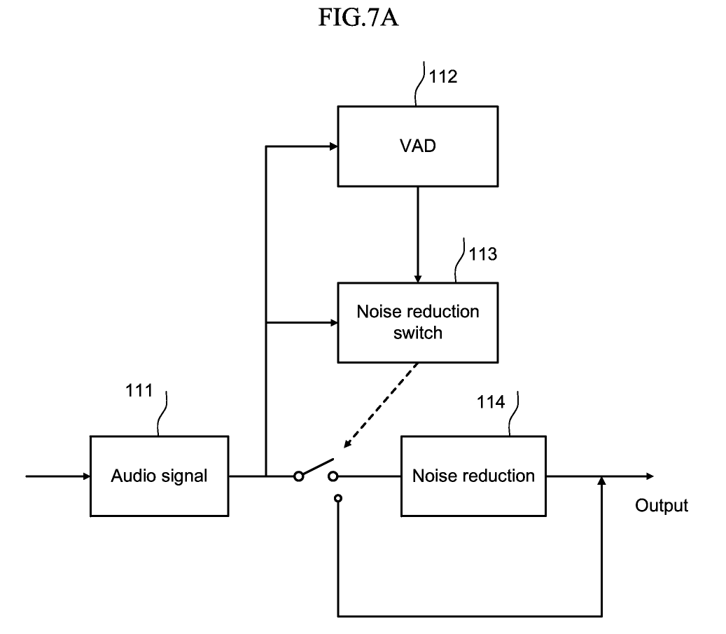

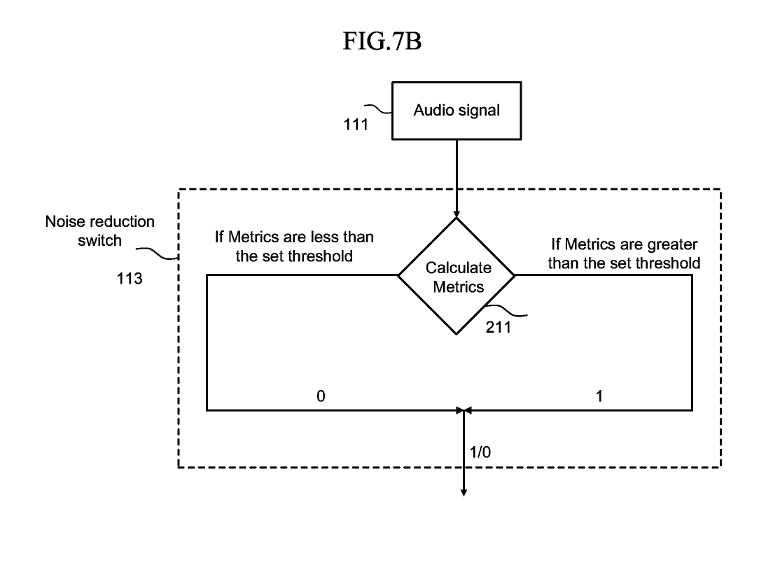

FIG. 7A shows various steps of the current invention involved in the process of enabling/disabling noise reduction. The audio signal is received at block 111. This audio signal may be the signal received in voice gateway, conference bridge etc. It may also be the signal(s) picked up by the communication device with one or M number of microphone(s), where M>1.

Block 112 is a Voice Activity Detector (VAD). It is a technique used to detect the presence and absence of speech. VAD is used in many applications such as noise reduction, echo cancellation, speech coding, speech recognition etc. Many techniques to implement the VAD are known in the art (energy based VAD^{S}, zero cross detector VAD^{S} etc). One technique is described by J. F. Lynch Jr., J. G. Josenhans and R. E. Crochiere in paper titled “Speech/Silence Segmentation for real-time coding via rule based adaptive endpoint detection”, which is incorporated herein by reference. The purpose of the VAD is to decide if the audio signal is speech or noise/non-speech.

Block 113 is the noise reduction switch which makes a decision whether to enable or disable the noise reduction capability of a communication device. This decision can be a simple binary 1 or 0 or in general can be in any machine readable format. Block 114 is the noise reduction algorithm of the communication device which reduces or removes the background noise from the audio signal. Several noise reduction algorithms are known in the art. One such technique is described by Steven F. Boll in “Suppression of Acoustic Noise in Speech Using Spectral Subtraction”, IEEE Transactions on Acoustics, Speech, and Signal Processing, Vol. Assp-27, No. 2, April 1979 and is incorporated herein by reference.

If the noise reduction switch decision is “1”, the audio signal is modified by the noise reduction algorithm. If the noise reduction switch decision is “0”, the audio signal is by-passed or untouched or unmodified etc.

FIG. 7B shows the details involved in the noise reduction switch. The audio signal is received at block 111. Metrics are calculated at block 211. If the metrics are less than the set threshold, the noise reduction switch decision is “0”. If the metrics are greater than the set threshold, the noise reduction switch decision is “1”. Various metrics may be calculated. These include, but not limited to, Root Mean Square (RMS) value, Mean Squared value, Energy, Power, Power Spectral Density (PSD) etc of the audio signal.

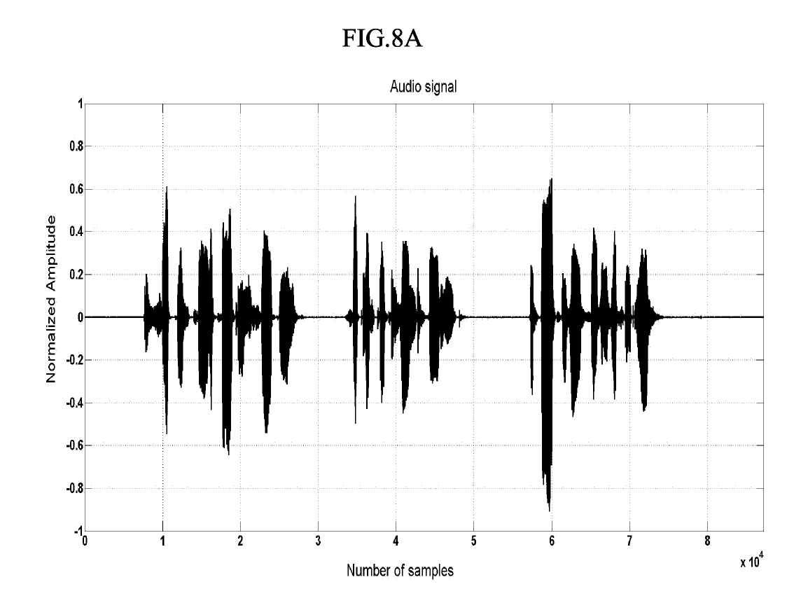

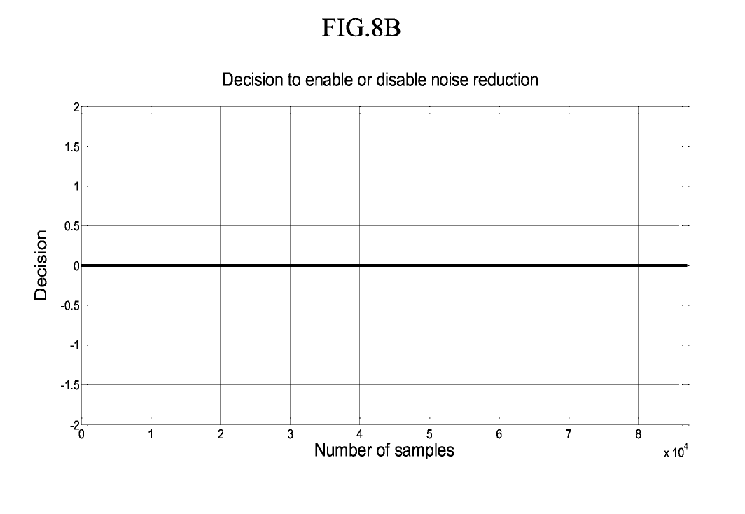

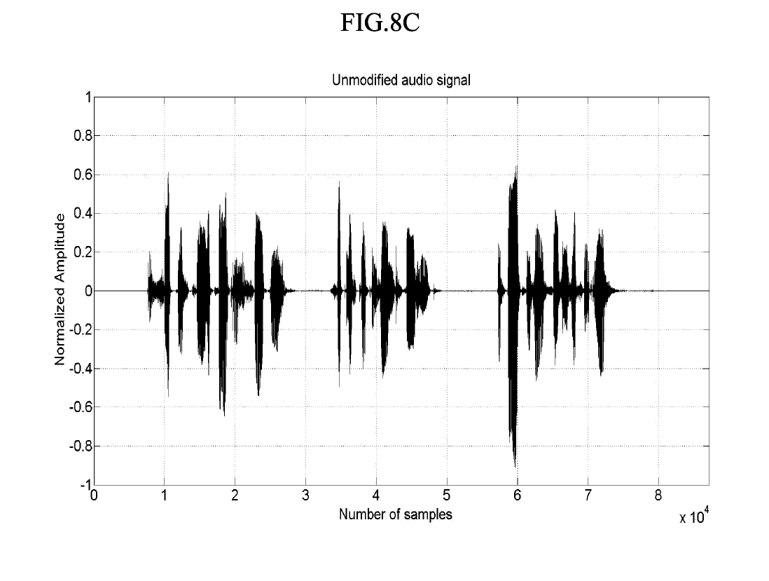

FIG. 8A shows the plot of clean speech file with no background noise. The x-axis represents the number of samples and the y-axis represents the normalized amplitude [−1 1] of the audio signal. [−1 1] represents +32,767 to −32768 for 16-bit audio codecs.

FIG. 8B shows the plot of the decision to noise reduction for the audio signal described in FIG. 8A. If the noise reduction switch decision is “0”, the audio signal is not modified and is by-passed. If the noise reduction switch decision is “1”, then the audio signal is modified with the noise reduction algorithm. Various metrics including, but not limited, to RMS value Mean Squared value, Energy, Power, PSD are calculated for the audio signal. Because the calculated metrics were less than the set threshold, the noise reduction switch decision is always 0.

As the noise reduction switch makes a decision of “1”, the audio signal described in FIG. 8A is modified and the noise is reduced or removed as shown in FIG. 8C.

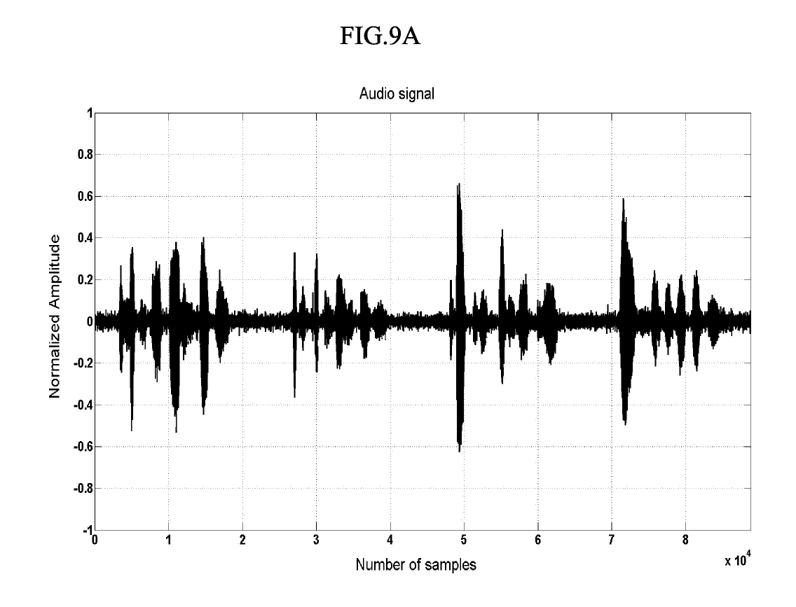

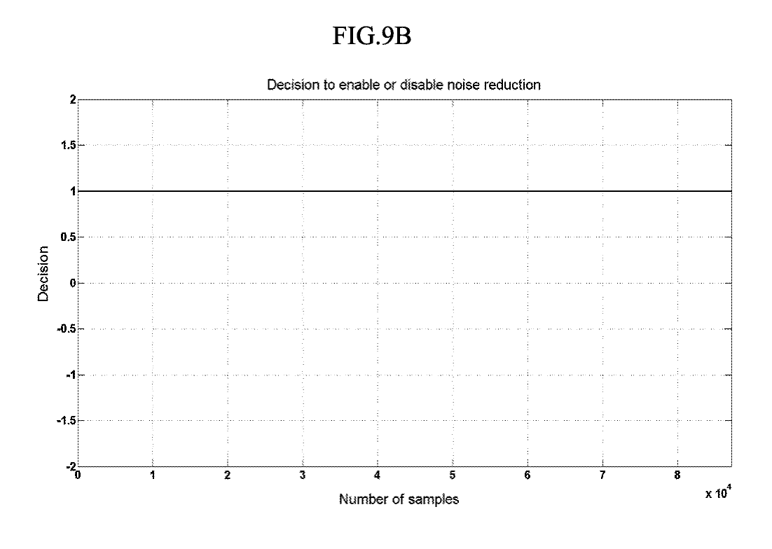

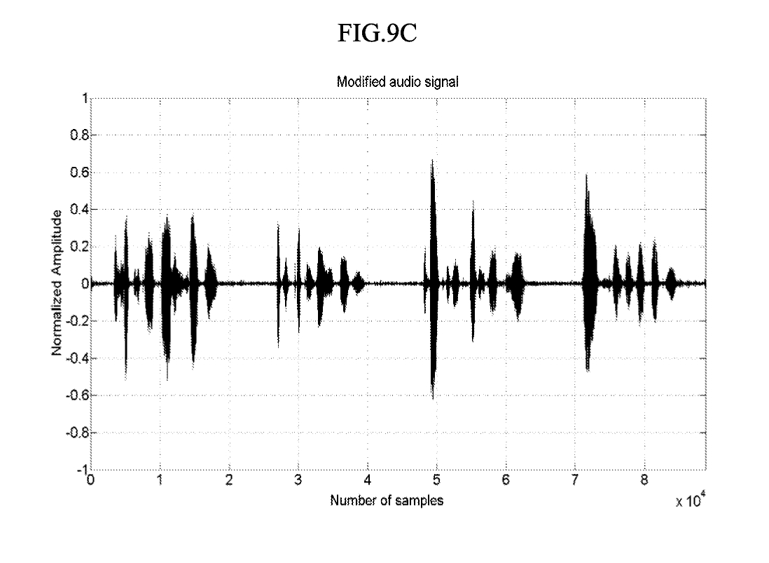

FIG. 9A shows the plot of clean speech file corrupted with background noise (street noise). The x-axis represents the number of samples and the y-axis represents the normalized amplitude [−1 1] of the audio signal. [−1 1] represents +32,767 to −32768 for 16-bit audio codecs.

FIG. 9B shows the plot of the decision to noise reduction for the audio signal described in FIG. 9A. If the noise reduction switch decision is “0”, the audio signal is not modified and is by-passed. If the noise reduction switch decision is “1”, then the audio signal is modified with the noise reduction algorithm. Various metrics including, but not limited, to RMS value Mean Squared value, Energy, Power, PSD are calculated for the audio signal. Because the calculated metrics were greater than the set threshold, the noise reduction switch decision is always 1.

As the noise reduction switch makes a decision of “1”, the audio signal described in FIG. 9A is modified and the noise is reduced or removed as shown in FIG. 9C.

What is claimed is:

1. A device for generating an enhanced audio signal, comprising:
at least one transducer configured to receive an input audio signal; and
a noise reduction switch configured to:
calculate a value for a set of metrics associated with the input audio signal; and
compare the value of the set of calculated metrics with a predefined threshold value; and
generate the enhanced audio signal from the input audio signal by reducing noise in the input audio signal based on said comparison, wherein the noise is reduced if the value of the set of calculated metrics differ from the predefined threshold value.

2. The device of claim 1, wherein the noise being reduced if the value of the set of calculated metrics is greater than the predefined threshold value.

3. The device of claim 1, wherein the set of calculated metrics include at least one of a Root Mean Square (RMS) value, a mean square value, energy, power, Power Spectral Density (PSD), or predefined portions of bandwidth of the input audio signal.

4. The device of claim 1, wherein the predefined threshold value being set before receiving the input audio signal.

5. The device of claim 1, wherein the predefined threshold value being set during receiving the input audio signal.

6. A device for generating an enhanced audio signal, comprising:
a memory comprising one or more instructions for:
calculating a value for a set of metrics associated with the input audio signal; and
comparing the value of the set of calculated metrics with a predefined threshold value; and
generating the enhanced audio signal from the input audio signal by reducing noise in the input audio signal based on said comparison, wherein the noise is reduced if the value of the set of calculated metrics differ from the predefined threshold value; and
a processor coupled to the memory and configured to execute one or more instructions.

7. The device of claim 6, wherein the set of calculated metrics include at least one of a Root Mean Square (RMS) value, a mean square value, energy, power, Power Spectral Density (PSD), or predefined portions of bandwidth of the input audio signal.

8. The device of claim 6, wherein the noise being reduced if the value of the set of calculated metrics is greater than the predefined threshold value.

9. The device of claim 6, wherein the predefined threshold value being set before receiving the input audio signal.

10. The device of claim 6, wherein the predefined threshold value being set during receiving the input audio signal.

11. The device of claim 6, wherein the memory further comprising one or more instructions for switching on the processor.

12. The device of claim 6, wherein the memory further comprising one or more instructions for switching off the processor.

13. A method for generating an enhanced audio signal, comprising:
calculating, by a noise reduction switch, a value for a set of metrics associated with the input audio signal; and
comparing, by a noise reduction switch, the value of the set of calculated metrics with a predefined threshold value; and
generating, by a noise reduction switch, the enhanced audio signal from the input audio signal by reducing noise in the input audio signal based on said comparison, wherein the noise is reduced if the value of the set of calculated metrics differ from the predefined threshold value.

14. The method of claim 13, wherein the set of calculated metrics include at least one of a Root Mean Square (RMS) value, a mean square value, energy, power, Power Spectral Density (PSD), or predefined portions of bandwidth of the input audio signal.

15. The method of claim 13, wherein the noise being reduced if the value of the set of calculated metrics is greater than the predefined threshold value.

16. The method of claim 13, wherein the predefined threshold value being set before receiving the input audio signal.

17. The method of claim 13, wherein the predefined threshold value being set during receiving the input audio signal.

18. The method of claim 13, further comprising switching on the noise reducing switch based on the comparison.

19. The method of claim 18, wherein the noise reduction switch being switched on if the value of the set of calculated metrics is greater than the predefined threshold value.

20. The method of claim 13, further comprising switching off the noise reduction switch based on the comparison.
